(19) United States
(12) Patent Application Publication
(10) Pub. No.: US 2016/0060183 A1
(43) Pub. Date: Mar. 3, 2016

(54) GIBBERELLIC ACID (GA3) FREE KAPPAPHYCUS ALVAREZII SAP AND ITS APPLICATION THEREOF

(71) Applicant: COUNCIL OF SCIENTIFIC & INDUSTRIAL RESEARCH, New Delhi (IN)

(72) Inventors: Pushpito Kumar GHOSH, Bhavnagar (IN); Arup GHOSH, Bhavnagar (IN); Dibyendu MONDAL, Bhavnagar (IN); Kamalesh PRASAD, Bhavnagar (IN); Pradeep Kumar AGARWAL, Bhavnagar (IN); Parinita AGARWAL, Bhavnagar (IN); Sudhakar Tukaramji ZODAPE, Bhavnagar (IN); Vijay Anand Kattaeri GOPALAKRISHNAN, Bhavnagar (IN)

(73) Assignee: Council of Scientific & Industrial Research, New Delhi (IN)

(21) Appl. No.: 14/783,980

(22) PCT Filed: Apr. 9, 2014
(86) PCT No.: PCT/IN2014/000224

§ 371 Date: Oct. 12, 2015

(30) Foreign Application Priority Data
Apr. 10, 2013 (IN) 1078/DEL/2013

(51) Int. Cl. C05F 11/00

(52) U.S. Cl. CPC C05F 11/00

(57) ABSTRACT

The present invention relates to a product Kappaphycus alvarezii seaweed sap free of Gibberellic acid (GA3) and its method of preparation. Kappaphycus alvarezii seaweed sap is a plant stimulant found to enhance yield and quality of a number of crops. Besides containing many macro- and micro-nutrients, there are many plant growth hormones present in Kappaphycus alvarezii sap. It has been observed that pristine Kappaphycus alvarezii sap and GA3 free sap enhanced grain yield but surprisingly selective removal of GA3 from the pristine sap had profound stimulating effect on total dry above ground biomass yield of maize over and above the pristine sap. Upon seed treatment with GA3 free sap, α-amylase enzyme activity in the germinating seed of mung bean is found to be increased. The foliar spray of GA3 free sap on tomato plants upregulated disease responsive genes (PR-3 and PR-5) as compared to pristine sap.

The following specification particularly describes the nature of this invention and the manner in which it is to be performed:

### FIELD OF THE INVENTION

The present invention relates to a gibberellic acid (GA₃) free Kappaphycus alvarezii sap Kappaphycus alvarezii sap free of gibberellic acid (GA₃) has a significant positive impact on the biomass production of crops compared to pristine kappaphycus alvarezii sap application, without any compromise on the grain yield advantage. Particularly, present invention provides GA₃ free sap formulation which upon seed treatment enhances α-amylase enzyme activity in germinating seeds. More particularly, present invention relates to process for the preparation of a formulation of Kappaphycus alvarezii sap free of gibberellic acid (GA₃). The foliar spray of GA₃ free sap upregulated the disease responsive genes (PR-3 and PR-5).

### BACKGROUND OF THE INVENTION

Increasing food production and biomass for energy are challenging goals for humanity. Being able to do so with low carbon and water footprints is also of critical importance. Liquid seaweed fertilizers are reported to have profound effect on productivity of crops. Seaweeds as a source of plant nutrients are also attractive because their cultivation is undertaken with no inputs of fertilizers or pesticides. As cultivation is undertaken in the sea, the water footprint is also negligible. The red seaweed, Kappaphycus alvarezii, is fast growing and cultivated commercially in tropical waters. A method of expelling the sap from the fresh seaweed was invented by us some time back and it has been established over the years that the sap is a potent low cost foliar spray which can raise the yield of many crops. Besides copious amounts of potash and inorganic micronutrients, indole 3-acetic acid (IAA), gibberellin (GA₃), kinetin and zeatin were reported to be present in the sap. Kappaphycus alvarezii sap was also found to contain substantial amounts of choline and glycine betaine, which are also known to play crucial roles as plant growth regulators. Since seaweed fertilizers are reportedly low in nutrients like nitrogen and phosphorus, it is known that their performance can be augmented through nutrient supplementation, e.g., through addition of protein hydrolysate. In the present invention the interest was to move in the opposite direction and to explore the feasibility of enhancing sap efficacy while simplifying its composition. Known evidence of cross talk between cytokinins and gibberellins forms the basis of the present invention. In the present invention a dramatic improvement in the above ground biomass yield (corn stover), without any compromise on the grain yield, as a result of selective removal of GA₃ from the Kappaphycus alvarezii sap has been observed.

Reference may be made to U.S. Pat. No. 6,893,479 wherein an integrated method for the preparation of Kappaphycus alvarezii sap is disclosed which consists of utilizing maximum extent of the fresh biomass of seaweeds such as Kappaphycus alvarezii followed by crushing to release sap and where the sap is useful as a potent liquid fertilizer after suitable treatment with additives.

Reference may be made to an article “Detection and quantification of some plant growth regulators in a seaweed-based foliar spray employing a mass spectrometric technique sans chromatographic separation”, in Journal of Agriculture and Food Chemistry (2010) 58: 4594-4601 which discloses that pristine sap from fresh Kappaphycus alvarezii seaweed contains indole acetic acid, GA₃, Kinetin, Zeatin besides several macro and micro nutrients.

Reference may be made to US20130005009 wherein integrated production of ethanol and seaweed sap are disclosed and the process consisting of: extracting the sap from fresh Kappaphycus followed by washing; hydrolyzing the carrageenan rich granules to obtain reducing sugar rich hydrolysate; recovering the solution to obtain hydrolysate; increasing the sugar concentration in the hydrolysate; adjusting the pH; separating insoluble salts; desalting the hydrolysate; enriching the hydrolysate; inoculating the yeast culture of Saccharomyces to hydrolysate and incubation to obtain ethanol.

Reference may be made to U.S. Pat. No. 8,252,359 wherein preparation a refreshing drink from marine algae Kappaphycus alvarezii involves treating a sap obtained from the algae with activated charcoal powder/carbon filter followed by membrane filtration and sterilization is disclosed.

Reference may be made to an article “Mechanisms of Cross Talk between Gibberellin and Other Hormones”, Plant Physiol 2007; 144: 1240-1246 by Weiss D and Ori N. wherein, evidences of cross talk between cytokinins and gibberellins are indicated.

### OBJECTIVES OF THE INVENTION

Main objective of the present invention is to provide gibberellic acid (GA₃) free Kappaphycus alvarezii sap.

Another objective of the present invention is to develop a formulation and a process for the preparation of kappaphycus alvarezii sap free from gibberellins (GA₃).

Yet another objective of the present invention is to extract GA₃ from Kappaphycus alvarezii sap under ≦60° C. to prevent degradation of other growth hormones.

Yet another objective of the present invention is to recover the GA₃ from the organic extractant used during the process which is a useful product that may find application for natural gibberellin supplementation wherever required.

Yet another objective of the present invention is to use kappaphycus alvarezii sap free of GA₃ for increasing biomass production of crop plants.

Yet another objective of the present invention is to separate GA₃ from kappaphycus alvarezii sap which improve expression of the cytokinins to enhance biomass production.

Yet another objective of the present invention is to foliar spray the GA₃ free kappaphycus alvarezii sap on maize (zea mays) plants.

Yet another objective of the present invention is to treat plant seeds with GA₃ free kappaphycus alvarezii sap for enhancement of α-amylase enzyme activity.

Yet another objective of the present invention is to use kappaphycus alvarezii sap free of GA₃ with water in the suitable ratio.

Yet another objective of the present invention is to use kappaphycus alvarezii sap free of GA₃ with water in the range of 1:5 to 1:20 ratio.

Yet another objective of the present invention is to spray kappaphycus alvarezii sap free of GA₃ with a spraying device three times during the crop season.

Yet another objective of the present invention is to spray kappaphycus alvarezii sap free of GA₃ with a spraying device three times during the crop season which includes early vegetative phase, tasseling/silk emergence stage and grain filling stage.

Yet another objective of the present invention is to apply kappaphycus alvarezii sap-free of GA₃ as a foliar spray or soil application.

Yet another objective of the present invention is to apply kappaphycus alvarezii sap free of GA₃ as a foliar spray and study the differential gene expression of disease responsive genes (PR-3 and PR-5).

### BRIEF DESCRIPTION OF THE DRAWING

FIG. 1: Mass fragmentation of GA₃ free K. alvarezii sap, absence of peak at m/z 345 indicates absence of GA₃.

FIG. 2 represents the effect of k-sap variants (control, pristine k-sap and GA3 free Kappaphycus alvarezii sap) on (a) CO₂ sequestration by maize and (b) energy content of maize plants. Data are average of three seasons.

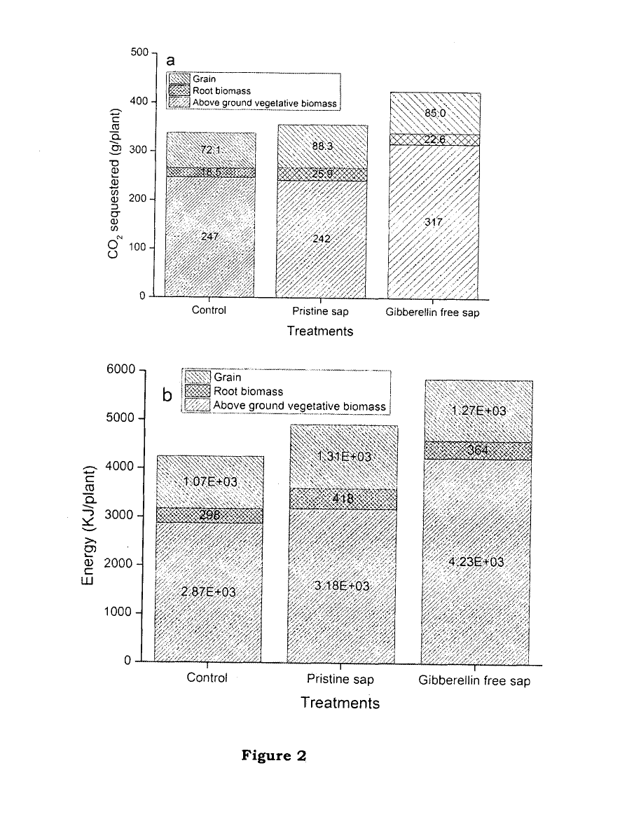

### SUMMARY OF THE INVENTION

Accordingly, present invention provides gibberellic acid free Kappaphycus alvarezii seaweed sap useful for 15-40% enhancement in the above ground biomass yield of maize compared to that obtained with the pristine Kappaphycus alvarezii sap without compromising grain yield.

In an embodiment of the present invention, said sap increases the average corn stover yield of maize plant by 28 to 33%, 15 to 20% and 27 to 32% during S₁ (season 1), S₂ (season 2) and S₃ (season 3), respectively, as compared to pristine K. alvarezii sap treatment.

In another embodiment of the present invention, said sap enhances the α-amylase enzyme activity by 2 to 3 folds in seeds of mung bean upon seed treatment during germination as compared to seed treatment with pristine K. alvarezii sap.

In yet another embodiment of the present invention, the expression of disease responsive genes PR-3 and PR-5 in tomato plants are up-regulated compared to the expression upon application of pristine sap.

In yet another embodiment of the present invention, the gibberellic acid probed for its removal by solvent extraction is GA₃.

In yet another embodiment of the present invention, the K. alvarezii sap contained IAA (Indole Acetic Acid), GA₃, kinetin, zeatin, glycine betaine and choline in the range of 22-24 ppm, 27-30 ppm, 7-9 ppm, 23-25 ppm, 75-80 ppm and 57-60 ppm, respectively, before extraction with ethyl acetate.

In yet another embodiment of the present invention, said sap contains IAA, GA₃, kinetin, zeatin, glycine betaine and choline in the range of 19-20 ppm, 0 ppm, 6-7 ppm, 18-20 ppm, 70-75 ppm and 48-55 ppm, respectively, after extraction with ethyl acetate.

In yet another embodiment of the present invention, residual ethyl acetate in the sap after extraction is confirmed to be below the detection limit which is less than 1-2 ppm.

In yet another embodiment, present invention provides a GA₃ free K. alvarezii sap formulation and its method of preparation comprising the steps of:
i. Collecting the pristine K. alvarezii sap through the known method of crushing and filtering the freshly harvested Kappaphycus alvarezii seaweed.
ii. Adjusting the pH of the pristine K. alvarezii sap to acidic through dropwise addition of dilute HCl.
iii. Partitioning the acidic K. alvarezii sap with equal volume of organic solvent.
iv. Separating the aqueous and organic layer.
v. Adjusting the pH of the aqueous layer to basic using NaOH.
vi. Heating the aqueous layer obtained in step (v)
vii. Partitioning the basic aqueous phase once again with organic solvent.
viii. Separating the organic and aqueous layer.
ix. Adjusting the pH of the remaining aqueous layer once again to acidic and followed the step (iii) and (iv).
x. Neutralizing the acidic aqueous layer with neutralizing agent and removing the residual ethyl acetate using rota vapour under reduced pressure.
xi. Adding suitable preservative to the neutralized aqueous substance to get GA₃ free K. alvarezii sap formulation.

In yet another embodiment of the present invention, said sap is obtained by solvent extraction with ethyl acetate wherein the ratio of pristine sap to ethyl acetate used is in the range of 2:1 to 1:1.

In yet another embodiment of the present invention, the acidic pH of the pristine K. alvarezii sap was adjusted to 2-3 using dilute HCl.

In yet another embodiment of the present invention, the basic pH of the aqueous phase was adjusted to 10-12 using NaOH.

In yet another embodiment of the present invention, during extraction process the sap is heated below 60° C.

In yet another embodiment of the present invention, the organic solvent which was used for partitioning was ethyl acetate.

In yet another embodiment of the present invention, the neutralizing agent was chosen as NaHCO₃.

In yet another embodiment of the present invention, the preservatives used was preferably potassium benzoate, methyl paraben and propyl paraben in suitable concentrations.

In yet another embodiment of the present invention, the yield of GA₃ free K. alvarezii sap formulation was 80-90% (v/v) with respect to initial volume of pristine K. alvarezii sap taken.

In yet another embodiment of the present invention, GA₃ free K. alvarezii sap formulation was used as foliar spray to crop plants.

In yet another embodiment of the present invention, GA₃ free K. alvarezii sap was applied to maize plant in suitable dilution ratio, preferably at 5% level (v/v).

In yet another embodiment of the present invention, GA₃ free K. alvarezii sap was foliar sprayed to maize plant at 5% (v/v) dilution for three consecutive seasons which not limited to dry and wet season.

In yet another embodiment of the present invention, GA₃ free K. alvarezii sap treatment increases the corn stover yield of maize plant by 30.3%, 18.2% and 29.6% during S₁ (season 1), S₂ (season 2) and S₃ (season 3), respectively, as compared to pristine K. alvarezii sap treatment

In yet another embodiment of the present invention, the increased corn stover yield was bestowed without diminution in grain yield as observed by pristine K. alvarezii sap treatment.

In yet another embodiment of the present invention, GA₃ free K. alvarezii sap treatment increases the photosynthetic rate (P_{N}) by 30.8% and 20.0%, over pristine Kalvarezii sap treatment during S₁ and S₂, respectively.

In yet another embodiment of the present invention, the seed treatment in mung bean with GA₃ free Kappaphycus alvarezii sap during germination resulted in a profound increase in the activity of α-amylase enzyme.

In yet another embodiment of the present invention, the foliar spray of GA3 free sap upregulated the disease responsive genes (PR-3 and PR-5).

In yet another embodiment of the present invention, is provided the use of Gibberellic acid free Kappaphycus alvarezii seaweed sap for 15-40% enhancement in the above ground biomass yield of maize compared to that obtained with the pristine Kappaphycus alvarezii sap without compromising grain yield and enhancing α-amylase enzyme activity.

### DETAILED DESCRIPTION OF THE INVENTION

Freshly harvested K. alvarezii, a red seaweed cultivated in the south east coast of India (9°15′N, 78°58′E) was crushed and filtered to obtain the pristine sap which was stored with preservatives as reported previously (U.S. Pat. No. 6,893,479; Journal of Agriculture and Food Chemistry (2010) 58: 4594-4601). The pH of the sap was adjusted to 2.5 by adding 3.2 N HCl dropwise followed by extraction with ethyl acetate (500 mL). The ethyl acetate layer was saved. The pH of the aqueous layer was once again adjusted to 11.0 by adding NaOH solution followed by heating on a water bath at 60° C. for 1 h, followed by extraction with equal volumes (500 mL) of ethyl acetate. This ethyl acetate extract was pooled with the previously saved ethyl acetate layer. The pH of the aqueous layer was once again adjusted to 2.5 by adding 1.6 N HCl dropwise followed by partitioning with ethyl acetate (500 mL) and the sap thus leftout was termed as GA₃ free sap (yield: 410 mL from 500 mL of sap). pH of the sap was 3.9 and was neutralized by adding NaHCO₃. The traces of ethyl acetate that could be present was removed by rotavapor under reduced pressure. This sap (F₂, Table 1) was applied as foliar spray to maize plants (Zea mays) in pot experiments for three consecutive seasons and biomass, grain yield and photosynthetic rate of the maize plants were compared with pristine sap (F₁) and also with control (water spray, F₀). The results of three seasons reveal that F₁ and F₂ brought about an average grain yield enhancement of 32.9% and 37.0%, respectively, over F₀ (water spray, control treatment). Most surprisingly, the above ground ligno-cellulosic biomass was on an average 24.9% higher for F₂ than F₁.

### EXAMPLES

The following examples are given by way of illustration and therefore should not be construed to limit the scope of the invention.

### Example 1

The pH of the pristine K. alvarezii sap (500 mL) was adjusted to 2.5 by dropwise addition of 3 N HCl followed by extraction with 500 mL of ethyl acetate. The organic layer was saved. The pH of the aqueous layer was adjusted to 11.0 by drop wise addition of 3.75 M NaOH followed by heating on a water bath at 60° C. for 1 h followed by single extraction with 500 mL ethyl acetate. This ethyl acetate extract was combined with the previously saved ethyl acetate layer. The pH of the aqueous layer was once again adjusted to 2.5 by dropwise addition of 1.6 N HCl followed by extraction once again with 500 mL of ethyl acetate. The volume of the aqueous layer obtained was 410 mL and its pH was 3.9. The pH was adjusted to 7 by adding NaHCO₃. Suitable preservatives were added. This is henceforth referred to as GA₃ free sap. The tiny amount of ethyl acetate was removed from the sap under reduced pressure.

This example teaches the preparation of GA₃ free K. alvarezii sap.

### Example 2

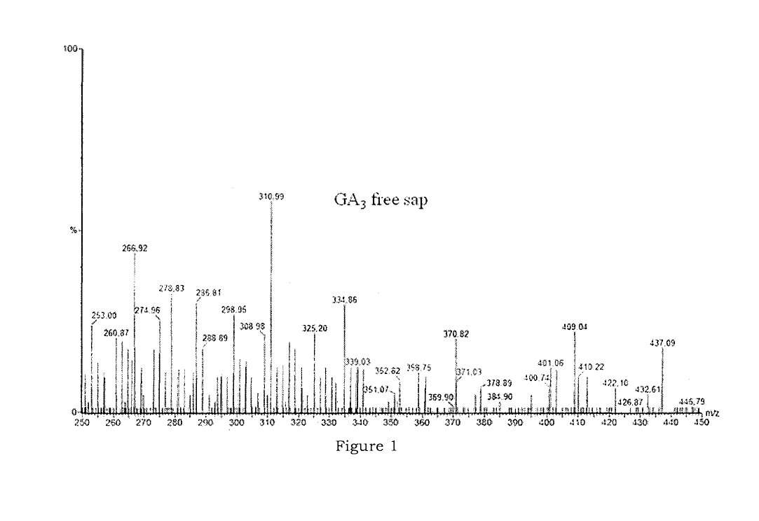

GA₃ was extracted from the above GA₃ free K. alvarezii sap (Example 1) to ensure complete removal of GA₃ from the sap as mentioned above. The organic extract (ethyl acetate fraction) thereafter characterized by electro-spray ionisation and tandem mass spectrometry method (ESI-MS/MS) as reported earlier (Journal of Agriculture and Food Chemistry (2010) 58: 4594-4601) and the spectra is shown below (FIG. 1). The absence of peak at m/z=345 confirms the absence of GA₃ in the GA₃ free K. alvarezii sap.

This example teaches that GA₃ free K. alvarezii sap was completely free of GA₃.

### Example 3

The concentrations of indole acetic acid, kinetin and zeatin in pristine K. alvarezii sap and GA₃ free K. alvarezii sap formulation were estimated by mass spectrometry following the procedure reported previously (Journal of Agriculture and Food Chemistry (2010) 58: 4594-4601). The presence of quaternary ammonium compounds was additionally probed following literature procedures for sample preparation (Journal of Agriculture and Food Chemistry (1997) 45:774-776) and mass spectrometric detection (Journal of Agriculture and Food Chemistry (2010) 58: 4594-4601). In a typical procedure, 10 mL of sap sample was diluted to 200 mL with distilled water followed by addition of 2% of charcoal and 10 mL of 6.5 N HCl. The solution was stirred at room temperature (25° C.) for 30 minutes. The resultant solution was filtered through a double layer of standard filter paper. The filtrate was subjected to electrospray ionization mass spectrometry (ESI-MS) and tandem mass spectrometry (MS-MS) in a Waters Q-Tof Micromass instrument equipped with an electrospray ionization interface, MCP detector and Waters MassLynx software (version 4.0). Samples were introduced with a syringe pump directly without further purification. Details of the concentration of different growth regulators are given in the table 1 below.

TABLE 1
Concentrations of IAA, GA₃, kinetin, zeatin, GB and choline
in pristine sap (F₁) and GA₃ free sap formulation (F₂).

| | IAA | GA₃ | Kinetin | Zeatin | Choline | GB |
|---|---|---|---|---|---|---|
| Formulations | (ppm) | (ppm) | (ppm) | (ppm) | (ppm) | (ppm) |
| Pristine | 23.4 | 27.9 | 7.94 | 23.97 | 57.3 | 79.3 |
| K. alvarezii | | | | | | |
| sap (F₁) | | | | | | |
| GA₃ free | 19.10 | 0.0 | 6.00 | 18.42 | 49.6 | 73.2 |
| K. alvarezii | | | | | | |
| sap (F₂) | | | | | | |

This example teaches that concentration of other growth regulators remains almost intact in the GA₃ free K. alvarezii sap formulation.

### Example 4

The foliar spray trials using different sap formulations, as described below, were set up using maize (Zea mays var. saccharata; F1 hybrid sweet corn, variety: Sugar-75, Syngenta India Ltd.) as the test crop which was seeded in pots in the CSIR-CSMCRI's net house facility in Bhavnagar district of Gujarat in India. Each pot was filled with 32 kg of soil. The soil was well drained sandy loam Entisol having pH of 7.2 and electrical conductivity of 0.2 dS m⁻¹. The soil had 0.5% organic carbon, 82.7 ppm available N, 3.55 ppm available P, and 90.3 ppm available K.

The experiments were laid out in completely randomized design (CRD) having foliar spray treatments comprising water spray (control); pristine K. alvarezii sap and GA₃ free K. alvarezii sap. The experiments were carried out in three consecutive seasons, first dry season referred as S₁ (November 2011 to February 2012); following wet season referred as S₂ (July 2012 to October 2012) and second dry season referred as S₃ (November 2012 to February 2013). The sap variants were applied at 5% (v/v) level and experiments were conducted in six replications during S₁ and S₂, and five replications during S₃. Standard agronomic practices were followed and all the treatments received uniform recommended doses of nutrients (3.8 g urea, 5.45 g single superphosphate and 0.97 g muriate of potash per pot). Three foliar sprays were applied to the maize plants 30, 50 and 70 days after planting.

The result of the trials revealed that compared to control, pristine K. alvarezii sap treatment recorded 25.8%, 35.3% and 35.2% improvement in grain yield of maize in S₁, S₂ and S₃, respectively, which were statistically significant in all the seasons (Table 2). As further shown in Table 2, GA₃ free K. alvarezii sap formulation was statistically at par with pristine K. alvarezii sap treatment with respect to grain yield. Whereas the grain yield was similar, a conspicuous observation was that the plants subjected to GA₃-free K. alvarezii sap treatment stood out from the rest with respect to dry above ground vegetative biomass (corn stover). Elimination of GA₃ from pristine K. alvarezii sap enhanced the corn stover yield by as much as 30.3%, 18.2% and 29.6% during S₁, S₂ and S₃, respectively. Data on net photosyntetic rate (P_{N}) were observed for the S₁ and S₂ seasons and they were largely consistent with the above observations (Table 2). GA₃ free K. alvarezii sap treatment effected 30.8% and 20.0% increase in P_{N}, over pristine K. alvarezii sap treatment during S₁ and S₂, respectively.

TABLE 2
Effect of different K. alvarezii sap formulations on net photosynthetic rate
(P_{N}), above-ground dry biomass (corn stover yield) and grain yield of maize

| | Net | | | | | | | |
|---|---|---|---|---|---|---|---|---|
| | photosynthetic | | Above-ground | | | | | |
| | rate (P_{N}) | | dry biomass | | | Grain yield | | |
| | (μmol CO₂ m⁻²s⁻¹) | | (g plant⁻¹) | | | (g plant⁻¹) | | |
| Treatments | S₁ | S₂ | S₁ | S₂ | S₃ | S₁ | S₂ | S₃ |
| Water spray (F₀) | 14.2^{b} | 19.5^{d} | 145.2^{bc} | 202.1^{d} | 148.5^{c} | 33.3^{b} | 49.6^{b} | 46.8^{b} |
| Pristine | 16.2^{ab} | 21.0^{c} | 136.0^{c} | 210.6^{cd} | 146.6^{c} | 41.9^{c} | 67.1^{a} | 63.3^{a} |
| K. alvarezii | | | | | | | | |
| sap (F₁) | | | | | | | | |
| GA₃ free | 21.1^{a} | 25.2^{a} | 177.1^{a} | 248.9^{a} | 190.0^{a} | 41.9^{a} | 70.0^{a} | 65.7^{a} |
| K. alvarezii | | | | | | | | |
| sap (F₂) | | | | | | | | |

Note:
The mean values marked with a different letter (a, b, c or d) are significantly different statistically between the treatments (p < 0.05). S₁, S₂ and S₃ refer to three different seasons.

This example teaches the enhanced efficacy of GA₃ free K. alvarezii sap as compared to pristine sap in increasing the photosynthetic rate and vegetative biomass of maize (corn stover yield) without compromising the grain yield advantage.

### Example 5

Seeds of mung bean (Vigna radiata syn: Phaseolus aureus) were treated by soaking them in distilled water for nine hours following which they were removed from the solution washed with distilled water. α-amylase enzyme activity in the seeds was assayed by homogenizing the treated seeds with liquid nitrogen and extracting 0.1 g of the sample with a buffer containing 1.5 ml ice cold solution of 100 mM HEPES-KOH (pH 7.5), 1 mM EDTA, 5 mM magnesium chloride, 5 mM DTT, 10 mM sodium bisulphite and 50 mM bovine serum albumin. The homogenate was centrifuged at 30000×g for 30 minutes and the supernatant was heated with 3 mM calcium chloride at 75° C. for 15 minutes to inactivate β-amylase and α-glucosidase. The heat treated supernatant (0.2 ml) was added to 0.5 ml of 100 mM sodium acetate (pH 6.0) containing 10 mM calcium chloride and 0.5 ml of 2% (w/v) starch solution and incubated at 37° C. for 15 minutes. After incubation, the reaction was stopped by adding 0.5 ml of 40 mM dinitrosalicylic acid solution containing 400 mM sodium hydroxide and 1 M sodium potassium tartrate and immediately placing them in a boiling water bath for 5 minutes. The reaction mixture was cooled to room temperature (25° C.) and then diluted with distilled water to 5 ml and their absorbance was measured at 530 nm. The amount of sugar released due to α-amylase enzyme activity was calculated from the standard curve obtained using glucose and was found to be 26 μmol/min/0.1 g of seed sample. One unit of enzyme activity was defined as the amount of enzyme required to release 1 μmol of glucose per min.

This example teaches about the activity of α-amylase enzyme in mung bean seeds by soaking it in water during germination.

### Example 6

Similarly, seeds of mung bean were treated by soaking them in diluted (200×) GA₃ free K. alvarezii sap and pristine K. alvarezii sap for nine hours and were assayed for α-amylase activity using dinitrosalicylic acid method as described in Example 5. The amount of sugar released from starch due to α-amylase activity following incubation in diluted (200×) GA₃ free and pristine K. alvarezii sap was found to be 80 μmol/min/0.1 g and 24 μmol/min/0.1 g of sample, respectively. This example teaches that seed treatment of mung bean with GA₃ free K. alvarezii sap during germination results in approximately three fold increase in α-amylase enzyme activity over pristine sap used at certain dilution.

### Example 7

Seeds of mung bean were soaked in diluted (100×) GA₃ free and pristine K. alvarezii sap for nine hours and were assayed for α-amylase enzyme activity using dinitrosalicylic acid method as described in Example 5. The amount of sugar released from starch due to α-amylase enzyme activity following incubation in diluted (100×) GA₃ free and pristine K. alvarezii sap was found to be 70 μmol/min/0.1 g and 32 μmol/min/0.1 g of sample respectively.

This example teaches that GA₃ free K. alvarezii sap brings about approximately two fold increase in α-amylase enzyme activity over pristine K. alvarezii sap used at certain dilution in mung bean during germination.

### Example 8

Real time Polymerase chain reaction (RT-PCR) was carried out for pathogenesis related genes (PR-3 and PR-5) using cDNA prepared from the pristine K. alvarezii sap and GA₃ free K. alvarezii sap treated tomato plants to analyse the differential expression. 15-20 days old tomato plants growing in ½ MS major and minor nutrients (Murashige T, Skoog F (1962) A revised medium for rapid growth and bioassays with tobacco tissue cultures. Physiol Plant 15:431-497) were subjected to both pristine and GA₃ free sap for 48 hours. Thereafter, the leaf tissue were collected, frozen in liquid nitrogen and stored in −80° C. The cDNA was prepared with 5 μg of total RNA isolated from frozen tissue in 20 μl reaction volume. The 1 μl of 1/10th diluted cDNA sample was used to carry out Real time PCR with PR-3 and PR-5 (target genes) gene specific primers and actin primers (reference gene). Finally the threshold cycle values obtained for PR-3 and PR-5 primers (target genes) and actin primers (reference gene) were used for relative expression analysis by Livak method (Livak K J, Schmittgen T D (2001) Analysis of relative gene expression data using real-time quantitative PCR and the 2(-Delta Delta C(T)) method. Methods 25:402-408). The results revealed the upregulation of PR-3 and PR-5 genes in response to GA₃ free sap as compared to pristine sap.

### Example 9

TABLE
Effect of different treatments on yield attributes,
yield and quality of grain of maize.

| | Length of cob | | | | Grain | | Grain crude | |
|---|---|---|---|---|---|---|---|---|
| | with set | | No. of grains | | carbohydrate | | protein | |
| Treat- | kernels (cm) | | plant⁻¹ | | (g plant⁻¹) | | (g plant⁻¹) | |
| ments | S1 | S2 | S1 | S2 | S1 | S2 | S1 | S2 |
| Water | 12.6b | 14.3b | 310b | 439b | 20.3c | 30.5b | 4.1c | 5.8b |
| spray | | | | | | | | |
| Pristine | 14.1a | 17.9a | 416a | 541a | 28.1a | 47.2a | 5.2b | 7.7a |
| K. | | | | | | | | |
| alvarezii | | | | | | | | |
| sap | | | | | | | | |
| GA3 free | 14.6a | 17.7a | 412a | 597a | 25.3ab | 46.1a | 6.3a | 9.1a |
| K. | | | | | | | | |
| alvarezii | | | | | | | | |
| sap | | | | | | | | |

The mean values marked with a different letter (a, b, c) are significantly different between the treatments (p < 0.05). S1, S2 and S3 refer to three different seasons.

### Example 10

TABLE
Effect of different treatments on chlorophyll index, net photosynthetic
rate (PN), transpiration rate (Tr) and vegetative biomass of maize

| | Chlorophyll | | | | Dry root biomass | | |
|---|---|---|---|---|---|---|---|
| | index (CI) | | Tr (mol m⁻² s⁻¹) | | (g plant⁻¹) | | |
| Treatments | S1 | S2 | S1 | S2 | S1 | S2 | S3 |
| Water spray | 38.3c | 44.5c | 1.55c | 2.26d | 15.2b | 10.1c | 15.4a |
| Pristine | 61.9ab | 63.5b | 2.27bc | 2.42cd | 18.9a | 17.3a | 22.5b |
| K. alvarezii | | | | | | | |
| sap | | | | | | | |
| GA3 free | 72.2a | 75.1a | 3.80a | 3.09a | 16.0ab | 16.4a | 19.0b |
| K. alvarezii | | | | | | | |
| sap | | | | | | | |

The mean values marked with a different letter (a, b, c, d) are significantly different between the treatments (p < 0.05). ). S1, S2 and S3 refer to three different seasons.

### ADVANTAGES OF THE INVENTION

1. Preparation of a novel formulation based on Kappaphycus alvarezii sap by converting an analytical technique to isolate GA₃ for quantification into a production technique to prepare a sap formulation free of GA₃.
2. Application of the GA₃ free Kappaphycus alvarezii sap on maize or other plants as foliar spray.
3. GA₃ free Kappaphycus alvarezii sap has profound stimulating effect on total dry above ground biomass yield over and above the pristine sap without compromising grain yield.
4. Seed treatment in mung bean with GA₃ free Kappaphycus alvarezii sap during germination resulted in a profound increase in the activity of α-amylase enzyme.
5. The GA₃ free sap upregulated disease responsive genes (PR-3 and PR-5) as compared to pristine sap.

1. Gibberellic acid free Kappaphycus alvarezii seaweed sap useful for 15-40% enhancement in the above ground biomass yield of maize compared to that obtained with the pristine Kappaphycus alvarezii sap without compromising grain yield.

2. The seaweed sap as claimed in claim 1, wherein said sap increases the average corn stover yield of maize plant by 28 to 33%, 15 to 20% and 27 to 32% during S₁ (season 1), S₂ (season 2) and S₃ (season 3), respectively, as compared to pristine K. alvarezii sap treatment.

3. The seaweed sap as claimed in claim 1, wherein said sap enhances the α-amylase enzyme activity by 2 to 3 folds in seeds of mung bean upon seed treatment during germination as compared to seed treatment with pristine K. alvarezii sap.

4. The seaweed sap as claimed in claim 1, wherein the expression of disease responsive genes PR-3 and PR-5 in tomato plants are up-regulated compared to the expression upon application of pristine sap.

5. The seaweed sap as claimed in claim 1, wherein said sap is obtained by solvent extraction with ethyl acetate wherein the ratio of pristine sap to ethyl acetate used is in the range of 2:1 to 1:1.

6. The seaweed sap as claimed in claim 1, wherein during extraction process the sap is heated below 60° C.

7. The seaweed sap as claimed in claim 1, wherein the gibberellic acid probed for its removal by solvent extraction is GA₃.

8. The seaweed sap as claimed in claim 1, wherein the K. alvarezii sap contained IAA (Indole Acetic Acid), GA₃, kinetin, zeatin, glycine betaine and choline in the range of 22-24 ppm, 27-30 ppm, 7-9 ppm, 23-25 ppm, 75-80 ppm and 57-60 ppm, respectively, before extraction with ethyl acetate.

9. The seaweed sap as claimed in claim 1, wherein said sap contains IAA, GA₃, kinetin, zeatin, glycine betaine and choline in the range of 19-20 ppm, 0 ppm, 6-7 ppm, 18-20 ppm, 70-75 ppm and 48-55 ppm, respectively, after extraction with ethyl acetate.

10. The seaweed sap as claimed in claim 1, wherein residual ethyl acetate in the sap after extraction is confirmed to be below the detection limit which is less than 1-2 ppm.

11. A process for the preparation of Gibberellic acid free Kappaphycus alvarezii seaweed sap as claimed in claim 1, the said process comprising the steps of:
i. providing the pristine K. alvarezii sap containing 22-24 ppm IAA, 27-30 ppm GA₃, 7-9 ppm kinetin, 23-25 ppm zeatin, 75-80 ppm glycine betaine and 57-60 ppm choline by the known method;
ii. adjusting the pH of the sap as provided in step (i) in the range of to 2-3 with HCl to obtain acidic sap;
iii. extracting the acidic sap with organic solvent followed by separating the aqueous and organic layer;
iv. adjusting the pH of the aqueous layer as obtained in step (iii) in the range of 10-12 using NaOH to obtain basic aqueous phase;
v. Heating the aqueous layer obtained in step (iv);
vi. partitioning the basic aqueous phase once again with organic solvent followed by separating the organic and aqueous layer;
vii. adjusting the pH of the remaining aqueous layer once again to acidic and followed the step (iii) and (vi);
viii. neutralizing the acidic aqueous layer with neutralizing agent and removing the residual ethyl acetate using rota vapour under reduced pressure;
ix. Adding suitable preservative to the neutralized aqueous substance to get GA₃ free K. alvarezii sap formulation.

12. Use of Gibberellic acid free Kappaphycus alvarezii seaweed sap as claimed in claim 1, wherein said seaweed sap is useful for 15-40% enhancement in the above ground biomass yield of maize compared to that obtained with the pristine Kappaphycus alvarezii sap without compromising grain yield and enhancing α-amylase enzyme activity.
